(19) United States
(12) Patent Application Publication
(10) Pub. No.: US 2025/0056687 A1
(43) Pub. Date: Feb. 13, 2025

(54) MICROWAVE TREATMENT DEVICE

(71) Applicant: Mitsubishi Electric Corporation, Tokyo (JP)

(72) Inventor: Takumi SUGITANI, Tokyo (JP)

(73) Assignee: Mitsubishi Electric Corporation, Tokyo (JP)

(21) Appl. No.: 18/709,205

(22) PCT Filed: Mar. 15, 2022
(86) PCT No.: PCT/JP2022/011711

§ 371 Date: May 10, 2024

(51) Int. Cl. H05B 6/68; H05B 6/64; H05B 6/72

(52) U.S. Cl. CPC H05B 6/686; H05B 6/6455; H05B 6/688; H05B 6/72

(57) ABSTRACT

The microwave treatment device of the present disclosure includes a heating chamber that accommodates an object to be heated, a carrier signal generator that generates a carrier signal in a microwave band, a modulation signal generator that generates a modulation signal in an HF or UHF band, a modulation unit to which the carrier signal and the modulation signal are input, the modulation unit amplitude-modulating the carrier signal using the modulation signal, a first antenna that radiates an output signal output from the modulation unit into the heating chamber, and a re-radiation device that receives the output signal, extracts a frequency component of the modulation signal from the received output signal, and re-radiates the modulation signal into the heating chamber.

### FIELD

The present disclosure relates to a microwave treatment device.

### BACKGROUND

A microwave oven, which is one of microwave treatment devices, is known as being able to perform uniform heating cooking with heating cooking in which microwaves are used. On the other hand, thawing treatment by the microwave oven has problems such as thawing unevenness and boiling of a cooking object end portion because loss factors of water and ice are different.

Patent Literature 1 discloses, as means for solving the problem, a method of simultaneously using a microwave and a high frequency wave. The difference between the loss factors of water and ice is gentler in a frequency band lower than a microwave in a 2400 MHz band. Therefore, the microwave treatment device described in Patent Literature 1 includes oscillation sources of the microwave and the high frequency (HF) band. The microwave treatment device performs irradiation of a radio wave in the HF band in the thawing treatment to perform efficient thawing treatment.

### CITATION LIST

### Patent Literature

[PTL 1] JP 2019-143868 A.

### SUMMARY

### Technical Problem

However, in order to efficiently perform the thawing treatment with an electromagnetic wave in the HF band, it is necessary to perform irradiation on an object to be heated using a plurality of antennas. Therefore, a problem occurs in that peripheral equipment of the device increases in size.

In order to solve the problem described above, the present disclosure uses a re-radiation device that extracts, from a carrier signal amplitude-modulated using a modulation signal in an HF or ultrahigh frequency (UHF) band, which is a frequency lower than a microwave band, only a frequency component of the modulation signal and re-radiates the modulation signal. As a result, an object of the present disclosure is to provide a microwave treatment device that can perform efficient thawing treatment, in which an electromagnetic wave in the HF or UHF band is used, without increasing peripheral equipment of the device in size.

### Solution to Problem

The aspect of the present disclosure is preferably a microwave treatment device comprising of a heating chamber that accommodates an object to be heated, a carrier signal generator that generates a carrier signal in a microwave band, a modulation signal generator that generates a modulation signal in an HF or UHF band, a modulator to which the carrier signal and the modulation signal are input, the modulator amplitude-modulating the carrier signal using the modulation signal, a first antenna that radiates an output signal output from the modulator into the heating chamber, and a re-radiation device that receives the output signal, extracts a frequency component of the modulation signal from the received output signal, and re-radiates the modulation signal into the heating chamber.

### Advantageous Effects of Invention

According to the aspect of the present disclosure, it can provide a microwave treatment device that can perform efficient thawing treatment, in which an electromagnetic wave in the HF or UHF band is used, without increasing peripheral equipment of the device in size.

### BRIEF DESCRIPTION OF DRAWINGS

FIG. 1 is a diagram illustrating a configuration of a microwave oven of the related art.

FIG. 2 is a diagram illustrating a configuration of a heating cooker that uses an HF band electromagnetic wave of the related art.

FIG. 3 is diagrams illustrating a configuration of a microwave treatment device of the related art relating to problem solution.

FIG. 4 is diagrams illustrating a configuration of a microwave treatment device of the related art relating to problem solution.

FIG. 5 is a diagram illustrating a configuration of a microwave treatment device according to a first embodiment of the present disclosure.

FIG. 6 is a diagram illustrating a configuration of the re-radiation device according to the first embodiment.

FIG. 7 is a diagram illustrating a modification of the re-radiation device according to the first embodiment.

FIG. 8 is a graph illustrating a waveform of the signal s(t) in the case of the modulation index M=1.

FIG. 9 is a graph illustrating a frequency spectrum of the signal s(t) in the case in which the modulation index M is changed.

FIG. 10 is a diagram illustrating a configuration of a microwave treatment device according to a second embodiment of the present disclosure.

FIG. 11 is a diagram illustrating a configuration of a microwave treatment device according to a third embodiment of the present disclosure.

FIG. 12 is a diagram illustrating a configuration of a microwave treatment device according to a modification of the third embodiment of the present disclosure.

### DESCRIPTION OF EMBODIMENTS

### First Embodiment

### Configuration of a Related Art Example

Prior to explanation of a first embodiment, a configuration of a related art example is explained as a background. As a method of storing food, frozen storage of perishables such as meat and seafood, cooked food, and the like has been spread. In particular, in recent years, improvement of a freezing technique has made it possible to store food for a long period in a state in which the freshness of the food is maintained. Accordingly, there has been increasing demands for a thawing device that can perform thawing treatment without deteriorating freshness. As such a thawing device, a so-called microwave oven is known.

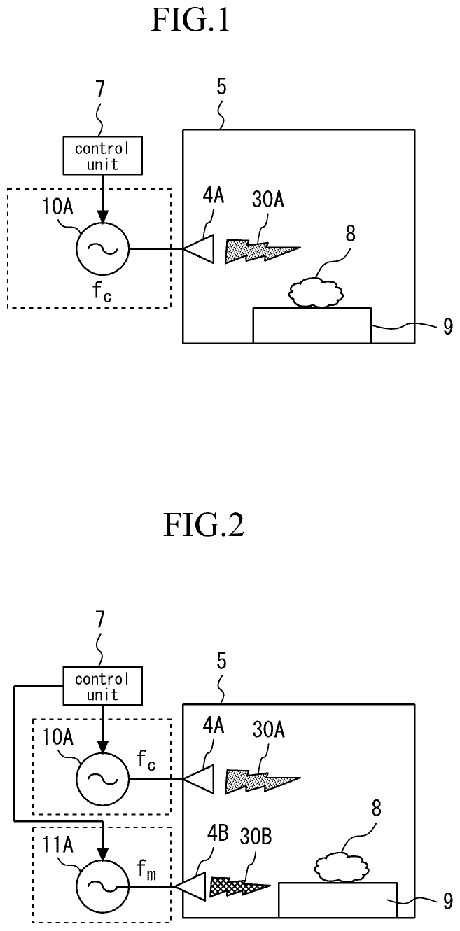

FIG. 1 is a diagram illustrating a configuration of a microwave oven of the related art. The microwave oven is a microwave treatment device that generally uses a 2450 MHz microwave and can perform thawing cooking and heating cooking. The microwave oven in the related art includes an oscillator 10A. The oscillator 10A is a large power direct oscillation device in which a magnetron, which is a type of a vacuum tube, is used. The oscillator 10A causes, according to a control signal of a control unit 7, the magnetron to generate an electromagnetic wave 30A. The electromagnetic wave 30A is radiated into a heating chamber 5 through an antenna 4A. In the heating chamber 5, an object to be heated 8 is placed on a placing table 9 and is heated by the electromagnetic wave 30A.

As a microwave for high-frequency heating, an ISM (Industrial, Scientific and Medical) band is used. An oscillation frequency of the magnetron is set to a predetermined value included in, for example, a range of 2400 MHz to 2500 MHZ. By using the microwave, for the heating cooking, generally uniform treatment can be performed on a cooking object.

However, for the thawing cooking, generally uniform treatment sometimes cannot be performed with simple microwave irradiation. As an example of a cause of this, a loss factor, which is an indicator of energy absorption efficiency, is greatly different between water and ice. For example, in a 2450 MHz microwave, energy absorbed by water is 1000 times as large as energy absorbed by ice. Therefore, between the peripheral edge portion of a cooking object that melts at a thawing early stage and the center of the cooking object that does not melt in the thawing early stage, a great difference occurs in energy to be absorbed. As a result, phenomena that cause quality deterioration such as thawing unevenness in which a heating state is nonuniform at the peripheral edge portion and the center of the cooking object and boiling in which only the peripheral edge portion is excessively heated occur.

To solve the problems, Patent Literature 1 discloses a heating cooker that efficiently performs thawing treatment using an electromagnetic wave in a high frequency (HF) band. It is known that a difference between loss factors of water and ice is relatively smaller in an HF band having a low frequency than a microwave having a high frequency. Therefore, in Patent Literature 1, thawing treatment is more efficiently performed by using the electromagnetic wave in the HF band such as 13560 kHz at the time of the thawing treatment than using the microwaves.

FIG. 2 is a diagram illustrating a configuration of a heating cooker that uses an HF band electromagnetic wave of the related art. A configuration of a heating cooker that controls a microwave and an electromagnetic wave in an HF band according to a state of a heating object disclosed in Patent Literature 1 is explained with reference to FIG. 2.

First, heating cooking other than thawing treatment is explained. The heating cooker includes an oscillator 10A. The oscillator 10A causes, according to a control signal of the control unit 7, a magnetron to generate an electromagnetic wave 30A. The electromagnetic wave 30A is radiated into the heating chamber 5 through the antenna 4A. In the heating chamber 5, the object to be heated 8 is placed on a placement table 9 and is heated by the electromagnetic wave 30A. This is the same in the microwave oven of the related art illustrated in FIG. 1.

Subsequently, the thawing treatment is explained. The heating cooker includes an oscillator 11A different from the oscillator 10A. The oscillator 11A is an oscillation source having any one frequency among 13560 kHz, 27120 kHz, and 40.68 MHz corresponding to the HF band of the ISM band. The oscillator 11A causes, according to a control signal of the control unit 7, the magnetron to generate an electromagnetic wave 30B. The electromagnetic wave 30B is radiated into the heating chamber 5 through an antenna 4B and thaws the object to be heated 8.

As explained above, the heating cooker illustrated in FIG. 2 uses the same microwave as the microwave of the related art in the heating cooking other than the thawing treatment and uses the electromagnetic wave in the HF band in the thawing treatment. Consequently, Patent Literature 1 provides a heating cooker that can perform efficient thawing treatment.

### Problems of the Related Art Example

Subsequently, problems of the related art example are explained. As an example of the problems of the related art example, an increase in the size of a device is unavoidable in order to improve efficiency of the thawing treatment using the electromagnetic wave in the HF band.

When a microwave oven for home use is used, a standing wave is generated inside a housing of the microwave oven. A part of an emitted microwave is absorbed by an object to be heated and the remainder is reflected inside the housing. This is to combine a reflected wave of the part of the microwave with an incident wave. Since the inner dimension of the housing is 30 cm to 40 cm, in the case of a 2400 MHz microwave, the wavelength of which is 12.5 cm in vacuum, a standing wave of the microwave can be present in the housing.

However, in the case of a 13560 kHz microwave, the wavelength of which in vacuum is 2300 cm, a standing wave is not produced in the housing and an environment in the housing is a near field. In the near field, radiation efficiency is higher as an antenna area is larger or a more plurality of antennas are installed.

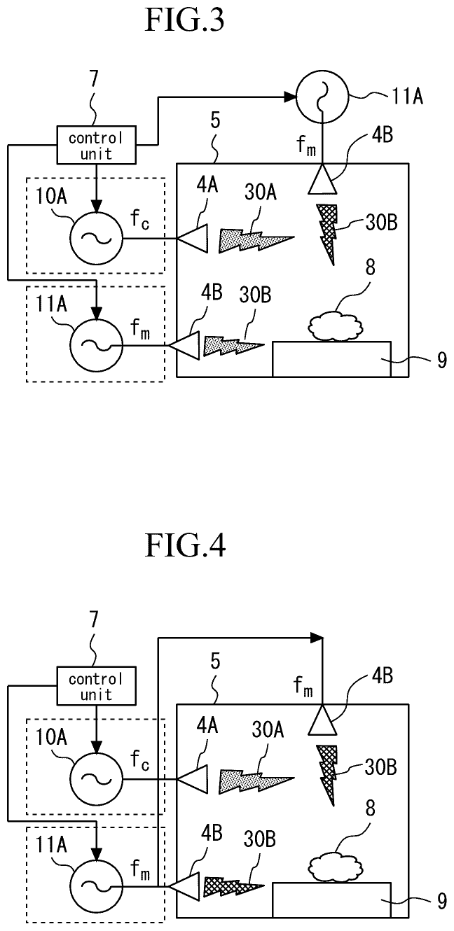

FIG. 3 and FIG. 4 are diagrams illustrating a configuration of a microwave treatment device of the related art relating to problem solution. As explained above, in order to efficiently perform the thawing treatment with the 13560 kHz electromagnetic wave, it is necessary to perform irradiation from the plurality of antennas to the object to be heated. For example, a method of installing a plurality of sets of oscillators 11A and antennas 4B as illustrated in FIG. 3 and a method of distributing an oscillation output of the oscillator 11A and feeding electricity to a plurality of antennas 4B as illustrated in FIG. 4 are conceivable. However, both of these methods lead to a problem of an increase in the size of peripheral equipment of the heating chamber 5. In the present disclosure, a microwave treatment device that solves this problem is provided.

### Configuration of a First Embodiment

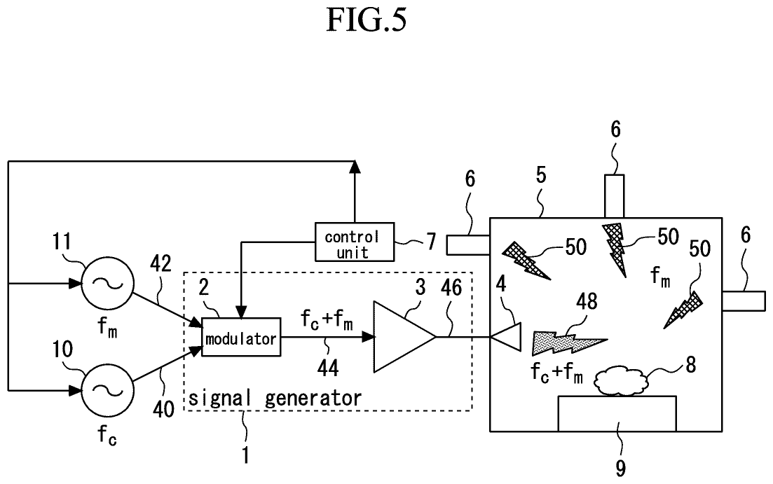

FIG. 5 is a diagram illustrating a configuration of a microwave treatment device according to a first embodiment of the present disclosure. The microwave treatment device according to the first embodiment includes a carrier signal generator 10. The carrier signal generator 10 generates a carrier signal 40 and outputs the carrier signal 40 to a modulator 2. A frequency of the carrier signal 40 is preferably 2450 MHz or 5800 MHz in the ISM band.

The microwave treatment device includes a modulation signal generator 11. The modulation signal generator 11 generates a modulation signal 42 and outputs the modulation signal to the modulator 2. A frequency of the modulation signal 42 is sufficiently lower than the frequency of the carrier signal 40. The frequency of the modulation signal 42 is preferably 13.56 MHz in the HF band or 860 to 960 MHz in the UHF band, international compatibility of which is ensured by the radio communication standard, and may be any one of 27120 kHz, 40.68 MHz, or 100±10 MHz.

The modulator 2 amplitude-modulates the input carrier signal 40 using the input modulation signal 42. The modulator 2 is implemented by, for example, a method by a nonlinear element for connecting a modulation signal amplifier and a carrier oscillator output in series to apply a signal to the nonlinear element or by switching modulation. The modulator 2 inputs an amplitude-modulated carrier signal 44 to a solid-state power amplifier 3.

The solid-state power amplifier 3 amplifies the carrier signal 44 and outputs an amplified carrier signal 46 to an antenna 4. In the solid-state power amplifier 3, a dielectric substrate is configured by a low dielectric loss material and a circuit is configured by a conductor pattern formed on one surface of the dielectric substrate. In order to cause semiconductor elements, which are amplification elements, to satisfactorily operate, matching circuits are respectively arranged on input sides and output sides of the semiconductor elements. The semiconductor elements can be implemented by, for example, an HEMT (High Electron Mobility Transistor), a MOSFET such as a lateral diffusion metal-oxide semiconductor field-effect transistor (LDMOSFET), or a bipolar junction transistor (BJT). Note that the semiconductor elements are not limited to a specific type.

The antenna 4 radiates the carrier signal 46 into the heating chamber 5. A re-radiation device 6 receives a carrier signal 48 radiated and extracts a frequency component of a modulation signal to re-radiate a modulation signal 50 to the heating chamber 5. An operation of the re-radiation device 6 is explained below.

The control unit 7 is connected to the carrier signal generator 10, the modulation signal generator 11, and the modulator 2. The control unit 7 changes ON and OFF of a signal, a frequency of a signal to be generated, output of a signal, and the like to control operations of the carrier signal generator 10 and the modulation signal generator 11. Further, the control unit 7 controls an operation of the modulator 2 to implement a change of a modulation index M and a burst operation explained below.

A microwave transmission line connecting the respective functional blocks forms a transmission circuit, a characteristic impedance of which is 50Ω, with the conductor pattern provided on one surface of the dielectric substrate.

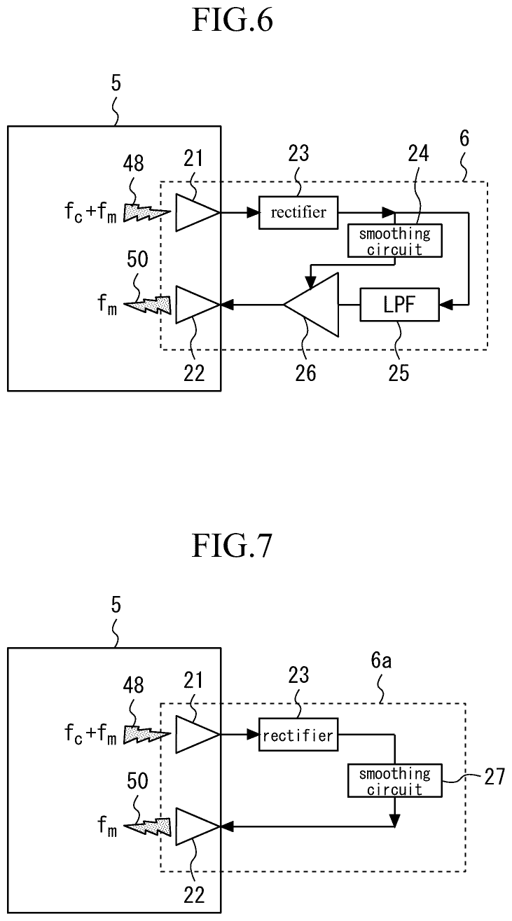

FIG. 6 is a diagram illustrating a configuration of the re-radiation device according to the first embodiment. The re-radiation device 6 extracts a frequency component of a modulation signal using an RFID (Radio Frequency Identification) technique. The re-radiation device 6 includes an antenna 21 that receives an electromagnetic wave in a microwave band. The antenna 21 receives the carrier signal 48 in the microwave band radiated from the antenna 4 into the heating chamber 5 and outputs the carrier signal 48 to a rectifier 23.

The rectifier 23 outputs the input carrier signal 48 to a smoothing circuit 24 and a low-pass filter (LPF) 25. The rectifier 23 can be implemented by, for example, a half-wave rectifier or a full-wave rectifier using a diode.

The smoothing circuit 24 smooths the input carrier signal, extracts a DC component, and supplies the carrier signal to an amplifier 26 as power source power. The LPF 25 extracts a frequency component of the modulation signal from the input carrier signal and supplies the modulation signal to the amplifier 26. The amplifier 26 amplifies the frequency component of the modulation signal extracted by the LPF 25. The amplifier 26 re-radiates the amplified modulation signal 50 into the heating chamber 5 via an antenna 22.

FIG. 7 is a diagram illustrating a modification of the re-radiation device according to the first embodiment. A re-radiation device 6a includes an envelope detection circuit formed by the rectifier 23 and a smoothing circuit 27. The modulation signal 50 is re-radiated into the heating chamber 5 by the circuit in the same manner as by the re-radiation device 6.

### Operation of the First Embodiment

Next, an operation is explained. A frequency of a carrier signal in the first embodiment is a 2400 MHz band of a microwave band and is represented as fc below. This is the same as a frequency of a general microwave heating device, a so-called microwave oven in Japan. A frequency of a modulation signal according to the first embodiment is 13.56 MHz in the HF band and is represented as fm below.

In the heating cooking, since only the carrier signal is caused to operate as in the microwave oven of the related art, amplitude modulation using the modulation signal is not performed. On the other hand, in the thawing cooking, irradiation of a signal amplitude-modulated by the modulation signal is performed. In this case, a signal s(t) output from the modulator 2 can be represented by the following expression.

$$s ( t ) = A \{ 1 + M cos ( 2 π {f}_{m} t ) \} cos ( 2 π {f}_{c} t ) \qquad [ Math . 1 ]$$

In Math. 1, A indicates an amplitude constant, M indicates a modulation index, and t indicates a time. The modulation index M satisfies 0≤M≤1. In the case of M=0, s(t) is a sine wave not modulated.

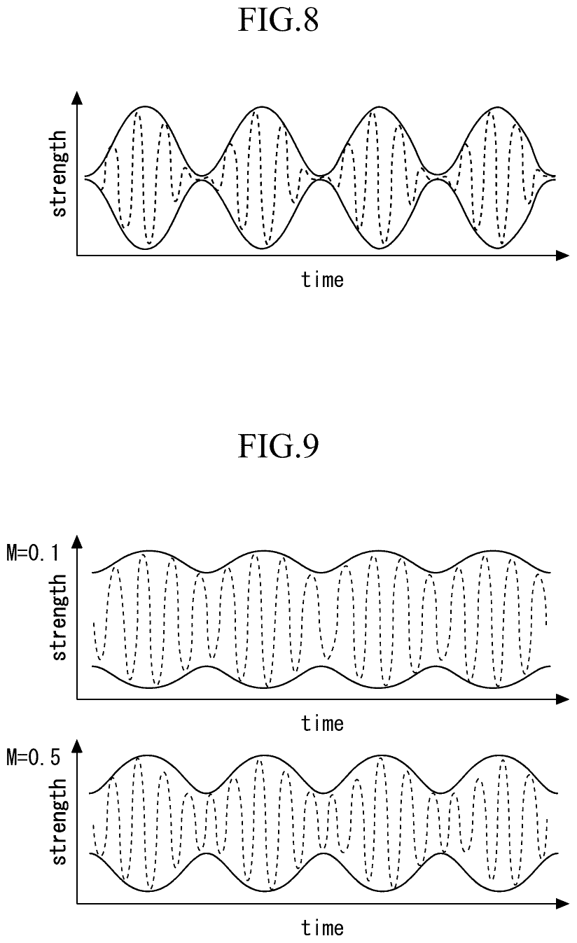

In the case of M>0, the amplitude of s(t) fluctuates and a frequency spectrum of s(t) has three peaks. FIG. 8 is a graph illustrating a waveform of the signal s(t) in the case of the modulation index M=1. In this case, an amplitude component of a wave of an amplitude modulation signal fluctuates as illustrated in FIG. 8. FIG. 9 is a graph illustrating a frequency spectrum of the signal s(t) in the case in which the modulation index M is changed. Here, waveforms in the case in which the modulation index M is changed to 0.1 and 0.5 are illustrated. It is seen that the magnitude of the fluctuation of the waveforms changes according to a value of the modulation index M. A frequency of a main peak is fc of a carrier frequency. Side bands, which are peaks present at both ends of the frequency, are generated in positions equally separated centering on fc like fc±fm. In this way, an amplitude component of fc does not change and only the amplitude of the side bands has a characteristic of being M/2. Average power of this carrier is given by A²/2.

By changing the value of the modulation index M, it is possible to adjust electric power in the HF band to be effective for thawing. This change corresponds to changing output power of fm. It is possible to perform uniform thawing without thawing unevenness by, for example, using M=1 with maximum output in a thawing early stage and using M=0.5 in a thawing later stage.

The carrier signal 48 radiated from the antenna 4 includes three 2400 MHz band signals of fc−fm, fc, and fm+fc formed by the carrier frequency fc in the 2400 MHz band and the modulation signal fm in the HF or UHF band. The object to be heated 8 is irradiated with the three 2400 MHz band signals and the three 2400 MHz band signals are input to the re-radiation device 6 provided in the heating chamber 5. In the re-radiation device 6, with the configuration illustrated in FIG. 6, the modulation signal 50, which is the signal fm in the HF or UHF band, is re-radiated by the antenna 22. The object to be heated 8 is irradiated with the modulation signal 50 as well.

Since electric power of the re-radiation device 6 is supplied by smoothing an input microwave band, a power distribution device and wires involved in the power distribution device or an oscillator dedicated to the HF or the UHF band is unnecessary. Therefore, it is possible to irradiate the object to be heated 8 with a signal in the HF or UHF band suitable for thawing, without increasing the size of peripheral equipment outside the heating chamber 5, only by adding re-radiation equipment for which an RFID technique is used. By installing a plurality of units of re-radiation equipment in the heating chamber 5, it is possible to irradiate the object to be heated 8 with signals in HF or UHF band from various directions. As a result, it is possible to efficiently implement thawing while suppressing an increase in the size of the peripheral equipment.

Note that the carrier signal may be a bust operation rather than a continuous wave illustrated in FIG. 8. In a microwave heating device not including radiation means in the HF band, a method of using the burst operation has been used in order to prevent nonuniform thawing cooking as much as possible. With the bust operation, since a time for thermal conduction inside a cooking object can be secured by intermittently irradiating a frozen cooking object with a microwave, uniform thawing treatment can be expected. A microwave heating and thawing device according to the present disclosure can perform re-radiation in the HF or UHF band even when the carrier signal is caused to perform the bust operation and irradiation of the carrier signal is intermittently performed. Therefore, it is possible to further suppress occurrence of thawing unevenness and the like compared with a microwave heating and thawing device of the related art that performs irradiation of only the 2400 MHz band.

In the first embodiment, as explained above, irradiation of electromagnetic waves having different frequencies are performed by switching the electromagnetic waves at the thawing treatment time and the other heating time by using a signal generator 1 configured from the modulator 2 and the solid-state power amplifier 3 and the re-radiation device 6 that extracts only a frequency component of a modulation signal from a signal and re-radiates the modulation signal. As a result, it is possible to realize efficient thawing treatment without increasing the device in size. Note that, although the effect can be obtained even by one re-radiation device, efficiency is improved when a plurality of re-radiation devices are installed.

### Second Embodiment

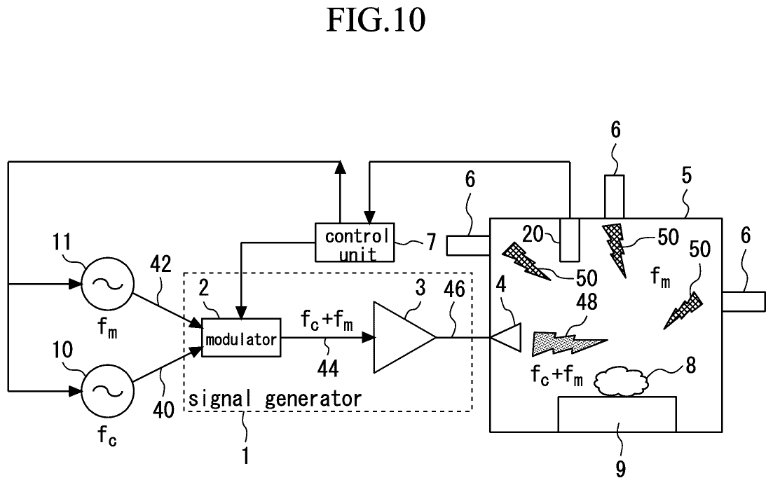

FIG. 10 is a diagram illustrating a configuration of a microwave treatment device according to a second embodiment of the present disclosure. The microwave treatment device according to the second embodiment includes, in addition to the components of the microwave treatment device according to the first embodiment, a temperature monitor 20 that detects the temperature of the object to be heated 8.

The temperature monitor 20 is electrically connected to the control unit 7. For example, the temperature monitor 20 includes an infrared sensor that detects an infrared ray radiated from the object to be heated 8 to measure the surface temperature of the object to be heated 8 in a noncontact manner. The temperature monitor 20 transmits detection information based on a detected temperature distribution of the object to be heated 8 to the control unit 7.

The control unit 7 determines a state of the object to be heated 8 during heating based on a comparison result of a preset target temperature and the detection information received from the temperature monitor 20. The control unit 7 controls the carrier signal generator 10, the modulation signal generator 11, and the modulator 2. For example, when the object to be heated 8 is in a frozen state, as explained above, the control unit 7 drives and amplitude-modulates the carrier signal and the modulation signal to intermittently irradiate the object to be heated with the microwave. When the detected temperature is equal to or higher than the target temperature, the control unit 7 determines that the thawing of the object to be heated 8 has been completed and inputs, to the modulator 2, a signal for inputting the modulation index M=0. By driving only the carrier signal in this way, only a signal in the 2400 MHz band used in normal heating is power-amplified by the solid-state power amplifier 3 and predetermined microwave power is output. The output is transmitted to the antenna 4 and radiated into the heating chamber 5.

The target temperature explained above is preferably a value with which it is possible to determine that the thawing of the object to be heated 8 has been completed and is set to, for example, 0° C. Note that the state in which the thawing of the object to be heated 8 is completed is not limited to a state in which the object to be heated 8 is completely thawed. The state in which the thawing of the object to be heated 8 is completed includes a case in which the object to be heated 8 is in a desired state like, for example, a half thawed state.

The control based on the target temperature may be control of using an analysis result of a temperature change. An absorption ratio of a high-frequency electromagnetic wave changes according to a melted state of the object to be heated 8. Since a temperature rise ratio changes according to the change, it is possible to grasp a thawed state by detecting an inflection point of the temperature change. It is possible to perform more accurate thawing control by performing thawing treatment corresponding to the thawed state.

In the second embodiment, as explained above, the carrier signal and the modulation signal are switched based on the detection result of the temperature monitor. As a result, it is possible to perform irradiation of appropriate microwave energy corresponding to a state of the object to be heated.

### Third Embodiment

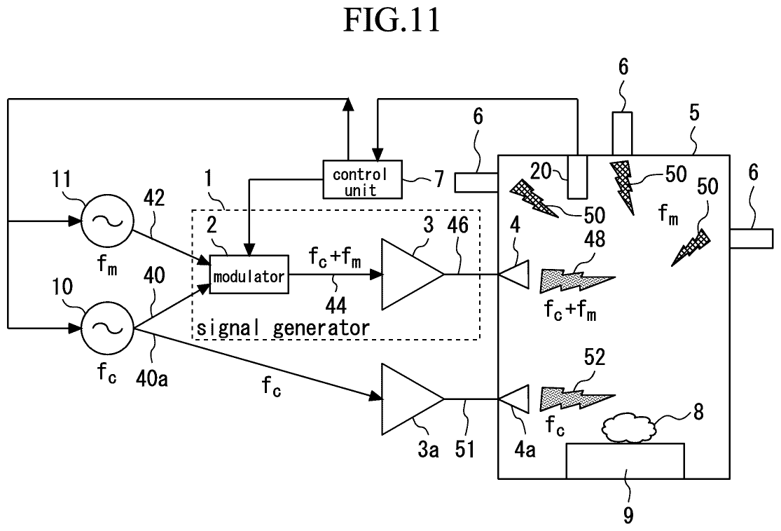

FIG. 11 is a diagram illustrating a configuration of a microwave treatment device according to a third embodiment of the present disclosure. The microwave treatment device according to the third embodiment includes, in addition to the components of the microwave treatment device according to the second embodiment, a new solid-state power amplifier 3a and a new antenna 4a. This makes it possible to simultaneously carry out thawing treatment using a modulation signal and other heating treatment using a carrier signal.

In the second embodiment, the irradiation of the microwave energy corresponding to the state of the object to be heated is performed by switching the carrier signal and the amplitude modulation signal. Therefore, in the second embodiment, the microwave treatment device includes only one set of the solid-state power amplifier 3 and the antenna 4. That is, when thawing is performed using the modulation signal, normal heating using only the carrier signal cannot be performed. However, since the thawing using the modulation signal requires a long time, a need to simultaneously carry out the thawing treatment using the modulation signal and the other heating treatment using the carrier signal is also conceivable. In this embodiment, a microwave heating and thawing device capable of simultaneously carrying out the thawing treatment using the modulation signal and the other heating treatment using the carrier signal is explained.

The microwave treatment device according to this embodiment includes, in addition to the components of the microwave treatment device according to the second embodiment, a solid-state power amplifier 3a and an antenna 4a. The solid-state power amplifier 3a amplifies a carrier signal 40a received from the carrier signal generator 10 and outputs an amplified carrier signal 51 to the antenna 4a. Therefore, a microwave 52, irradiation of which is performed from the antenna 4a, is the carrier signal 51.

Since the microwave treatment device includes the new solid-state power amplifier and the new antenna as explained above, it is possible to simultaneously carry out the thawing treatment using the modulation signal and the other heating treatment using the carrier signal.

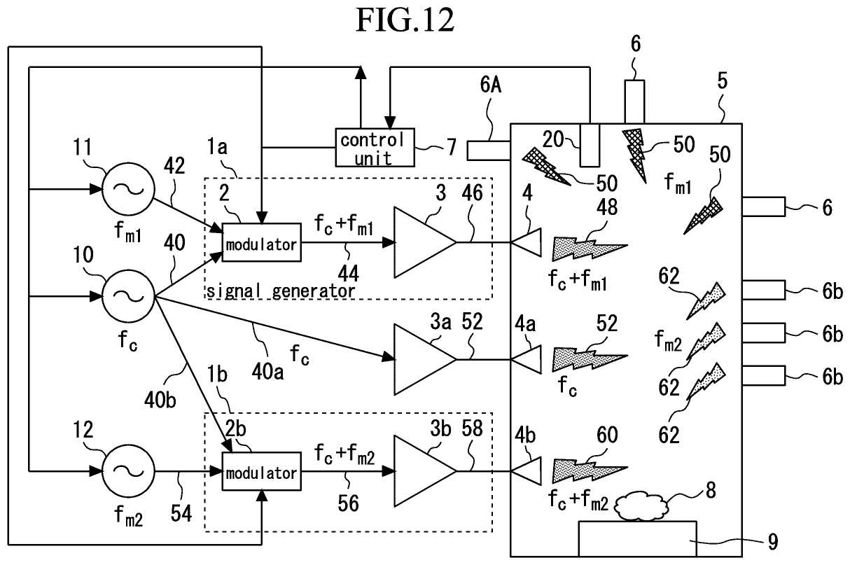

FIG. 12 is a diagram illustrating a configuration of a microwave treatment device according to a modification of the third embodiment of the present disclosure. The microwave treatment device includes, in addition to the components illustrated in FIG. 11, a new modulation signal generator 12 for an HF or UHF band, a new signal generator 1b, a new antenna 4b, and a new re-radiation device 6b. This makes it possible to simultaneously carry out thawing treatment involved in a plurality of modulation signals.

The microwave treatment device according to this modification includes the modulation signal generator 12 in addition to the components of the microwave treatment device illustrated in FIG. 11. The modulation signal generator 12 is an oscillation source of the HF or UHF band and generates a frequency different from the frequency generated by the modulation signal generator 11. The modulation signal generator 12 generates a modulation signal 54 and outputs the modulation signal 54 to a modulator 2b. The modulator 2b amplitude-modulates a carrier signal 40b input from the carrier signal generator 10 using the input modulation signal 54. The modulator 2b inputs an amplitude-modulated carrier signal 56 to a solid-state power amplifier 3b.

The solid-state power amplifier 3b amplifies the carrier signal 56 and outputs an amplified carrier signal 58 to the antenna 4b. The antenna 4b radiates a carrier signal 60 into the heating chamber 5. The carrier signal 60 is input to the re-radiation device 6b. The re-radiation device 6b is a re-radiation device configured to re-radiate a modulation signal of the modulation signal generator 12. Consequently, a modulation signal 62 is re-radiated into the heating chamber 5.

In this modification, as explained above, the microwave treatment device includes the new oscillation source of the HF band, the new signal generator, the new antenna, and the new re-radiation device. Therefore, it is possible to simultaneously carry out thawing treatment involved in a plurality of modulation signals.

In the solid-state power amplifier used in the present disclosure, at least one of semiconductor elements configuring the solid-state power amplifier may be formed by a wide bandgap semiconductor. The wide bandgap semiconductor is, for example, a silicon carbide or gallium nitride-based material or diamond. Semiconductor elements formed by the wide bandgap semiconductor have a high withstand voltage property and high allowable current density. Therefore, a semiconductor module incorporating these elements can be reduced in size.

The microwave treatment device explained in the present disclosure can perform irradiation of a microwave suitably for a state of a target object by power-amplifying an amplitude-modulated microwave with the solid-state power amplifier and performing irradiation of the microwave. That is, this technique is also applicable to uses other than the heating device using dielectric heating explained in the embodiment. Applicable examples include a microwave power supply used as a plasma power supply of a semiconductor manufacturing device and an organic synthesis system of a chemical industry. Note that the object to be heated and the heating chamber in the present disclosure correspond to an object to be treated and a treatment chamber in the case of the microwave power supply and correspond to a reaction object and a reaction chamber in the case of the organic synthesis system.

Note that, since the solid-state power amplifier is used in the present disclosure, there is an advantage that phase control and power synthesis by the phase control are possible. When irradiation of a microwave is performed by the magnetron as in the related art, an oscillation frequency of the microwave is fluctuated by a voltage applied to the magnetron and impedance in the heating chamber. Therefore, the microwave spreads to substantially the entire 100 MHz band width of 2400 MHz to 2500 MHz. However, when the solid-state power amplifier is used, microwave irradiation of a line spectrum without such a noise component can be implemented. Therefore, it is possible to greatly reduce possibility of the microwave becoming an interfering wave with electronic equipment around a microwave oven, in particular, a wireless LAN in the 2400 MHz band and it is possible to control output power and a phase. Since frequency stability and phase coherence are satisfactory as explained above, power synthesis by phase control is possible in a space.

Since the phase control is possible, output control such as selected area heating and uniform heating is possible for the object to be heated. Since power synthesis by the power control is possible, it is also possible to configure a high output system. For example, synthetic output power in a chamber from a plurality of solid-state power amplifiers 3 may include 1000 watts or more. For example, when megawatt class high output is necessary in the organic synthesis system, the high output can be implemented by synthesizing a kilowatt class solid-state power amplifier.

### REFERENCE SIGNS LIST

2, 2b modulator, 3, 3a, 3b solid-state power amplifier, 4, 4a, 4A, 4b, 4B antenna, 5 heating chamber, 6, 6a, 6b re-radiation device, 7 control unit, 8 object to be heated, 10 carrier signal generator, 11 modulation signal generator, 12 modulation signal generator, 20 temperature monitor, 21, 22 antenna, 23 rectifier, 24 smoothing circuit, 26 amplifier, 27 smoothing circuit, 40, 40a, 40b carrier signal, 42 modulation signal, 44, 46, 48 carrier signal, 50 modulation signal, 51 carrier signal, 52 microwave, 54 modulation signal, 56, 58, 60 carrier signal, 62 modulation signal

1. A microwave treatment device comprising:
a heating chamber that accommodates an object to be heated;
a carrier signal generator that generates a carrier signal in a microwave band;
a modulation signal generator that generates a modulation signal in an HF or UHF band;
a modulator to which the carrier signal and the modulation signal are input, the modulator amplitude-modulating the carrier signal using the modulation signal;
a first antenna that radiates an output signal output from the modulator into the heating chamber; and
a re-radiation device that receives the output signal, extracts a frequency component of the modulation signal from the received output signal, and re-radiates the modulation signal into the heating chamber.

2. The microwave treatment device according to claim 1, further comprising:
a solid-state power amplifier that power-amplifies the output signal; and
control circuitry that controls the amplitude modulation of the modulator.

3. The microwave treatment device according to claim 1, wherein the re-radiation device includes:
a second antenna that receives the output signal;
a rectifier that rectifies the output signal received by the second antenna;
a smoothing circuit that smooths a signal output from the rectifier and extracts a DC component; and
a third antenna that re-radiates a signal output from the smoothing circuit into the heating chamber.

4. The microwave treatment device according to claim 3, wherein the re-radiation device includes:
a low-pass filter that extracts a frequency component from the signal output from the rectifier; and
an amplifier that uses the DC component as power supply power and amplifies the frequency component.

5. The microwave treatment device according to claim 1, wherein
the carrier signal has a frequency of 2450 MHz or 5800 MHZ, and
the modulation signal has a frequency of 13.56 MHz or 860 to 960 MHz.

6. The microwave treatment device according to claim 1, further comprising a temperature monitor that detects a surface temperature of the object to be heated.

7. The microwave treatment device according to claim 2, wherein a semiconductor element configuring the solid-state power amplifier is formed by a wide bandgap semiconductor.

8. The microwave treatment device according to claim 7, wherein the wide bandgap semiconductor is a silicon carbide or gallium nitride-based material or diamond.

9. The microwave treatment device according to claim 2, wherein the re-radiation device includes:
a second antenna that receives the output signal;
a rectifier that rectifies the output signal received by the second antenna;
a smoothing circuit that smooths a signal output from the rectifier and extracts a DC component; and
a third antenna that re-radiates a signal output from the smoothing circuit into the heating chamber.
